(19) United States
(12) Patent Application Publication
(10) Pub. No.: US 2005/0081926 A1
(43) Pub. Date: Apr. 21, 2005

(54) First flush water diverter

(76) Inventor: Rodney George Wade, Upper Coomera (AU)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/688,886

(22) Filed: Oct. 21, 2003

(51) Int. Cl. G05D 7/00

(52) U.S. Cl. 137/593

(57) ABSTRACT

A first flush water diverter for use with domestic rainwater collection systems. The diverter comprises a T-piece (13) and a collection chamber (14), with an outlet (15) connectable to a hose by way of a flow control valve (24) and hose connector (25). The collection chamber (14) is variable in length to suit the environment and size of the roof from which the rainwater flows. The carrying capacity of the collection chamber (14), and have its length, is determined from the formula:
DF=RA×PF×1000 where DF is the rainwater carrying capacity, or diversion factor, measured in litres, RA is the associated roof area measured in square metres, PF is the Pollution Factor for the roof location which is determined on site and varies between 0.0005 for light pollution locations and 0.002 for heavy pollution locations, and wherein said collection chamber includes an outlet and associated flow control valve to regulate the flow of diverted rainwater from the collection chamber.

### BACKGROUND OF THE INVENTION

This invention relates to rainwater collection systems and in particular to apparatus for separating an initial flow of contaminated rainwater from rainwater flowing from a collection area to a storage or usage area. The invention is an improvement or modification of the invention described and claimed in my Australian Patent Specification No. 692835.

In my aforementioned patent specification, I describe an apparatus for diverting an initial flow of rainwater from the roof of a domestic building which comprises a T-piece with associated rainwater fall pipe. The T-piece is adapted for insertion into the rainwater flow path suitably between the roof gutter and the downpipe. The fall pipe is of a uniform diameter similar to that of the downpipe and includes a float which seals on a seat when the fall pipe is at least partly full of water. An outlet at the bottom of the fall pipe limits the rate of flow from the fall pipe in comparison with the rate of maximum flow of rainwater which can enter the fall pipe by way of the T-piece connection. Means are provided to enable solid contaminants to be removed from the fall pipe.

The principle of operation of the aforementioned apparatus is that an initial volume of contaminated rainwater flows into the fall pipe and causes the float to move against its seat and seal the fall pipe so that further rainwater by-passes the fall pipe. The contaminated rainwater is released from the fall pipe at a restricted flow rate. Preferably, the rate of release is regulated by such means as a valve fitted to the base of the rainwater fall pipe or by means of a barrier of permeable material. The regulation may, however, be by means of a device located away from the fall pipe in which case a conduit is provided in fluid communication between the fall pipe and the device.

The aforementioned apparatus has proved to be a very effective and commercially viable means for enabling the diversion of contaminated rainwater before entering a storage or usage domain, in a large number of situations. However, as rainwater collection has become more prevalent and consequently more regulated, it has become evident that there is a need for water diverters of varying capacity for each downpipe based upon the area of the roof which is serviced by the downpipe.

Following detailed investigation and research, I have been instrumental in establishing a pollution factor for a catchment area which is based upon the area of the roof serviced by a downpipe. This pollution factor has become an industry developed standard and is related to the quantity of rainwater diversion by the following formula:
Diversion Factor (litres)=Roof Area×Pollution Factor×1000
where the Pollution Factor is 0.0005 for minimal pollution situations, such as in open fields where there are no trees or bird droppings, and is 0.002 for substantial pollution situations, such as where there are shedding trees, bird droppings and insect matter.

Specific practical examples applying such a formula are as follows:
(1) For a minimally polluted roof having a surface area of 100 m², the rainwater to be diverted is 100×0.0005×1000, that is 50 litres.
(2) For a heavily polluted roof having a surface area of 100 m², the rainwater to be diverted is 100×0.002×1000, that is 200 litres.

There are currently no rainwater first flush diversion systems on the market that can be ordered to handle varying volumes of rainwater. As noted above, my own apparatus utilized a fall pipe of uniform diameter which in many instances meant that the pipe length could not be made long enough, before it touched the ground, to hold the required capacity.

There is consequently a need for a first flush water diverter available off the shelf in a size which enables the appropriate health standards set by the official codes, to be met.

### OBJECT OF THE INVENTION

It is therefore an objection of the invention to provide a first flush water diverter which meets the aforementioned requirements.

### SUMMARY OF THE INVENTION

According to the present invention there is provided a first flush water diverter comprising a T-piece with associated rainwater collection chamber, which T-piece is adapted for connection in a rainwater flow path to intercept the flow of rainwater from a roof into a downpipe or directly to a storage or usage area, said collection chamber including a float which seals on a seat adjacent a T-piece inlet to the collection chamber when the collection chamber is charged with rainwater and having a diameter which is an integral multiple of the diameter of the T-piece inlet, the said collection chamber having a rainwater carrying capacity defined by the formula:
DF=RA×PF×1000
where
DF is the rainwater carrying capacity, or diversion factor, measured in litres,
RA is the associated roof area measured in square metres,
PF is the Pollution Factor for the roof location which is determined on site and varies between 0.0005 for light pollution locations and 0.002 for heavy pollution locations,
and wherein said collection chamber includes an outlet and associated flow control valve to regulate the flow of diverted rainwater from the collection chamber.

### DESCRIPTION OF THE INVENTION

Once the required rainwater carrying capacity for the collection chamber has been determined for a particular roof area, using the aforementioned formula, it is then simply a matter of ascertaining what length of standard diameter collection chamber meets this requirement. For a typical collection chamber, formed from cylindrical pipe having a diameter of 300 mm, suitable lengths for specific volumes are provided in the following table. This table also indicates the total height required between the ground and the level at which the rainwater flows along the T-piece into the collection chamber. This height takes account of the space required for the outlet and associated flow control valve which are typically located below the chamber.

| Capacity of | Length of | Height between T- |
|---|---|---|
| Collection Chamber | Collection Chamber | piece inlet and |
| (liters) | (mm) | ground (mm) |
| 20 | 225 | 590 |
| 30 | 365 | 730 |
| 40 | 500 | 865 |
| 50 | 630 | 995 |
| 60 | 780 | 1145 |
| 70 | 905 | 1270 |
| 80 | 1050 | 1415 |
| 90 | 1180 | 1545 |
| 100 | 1310 | 1675 |
| 120 | 1610 | 1975 |
| 130 | 1735 | 2100 |
| 150 | 2005 | 2370 |

The collection chamber pipe is cut to the desired length and a cap for connection to the T-piece is joined to one end and a receptacle containing the outlet and flow control valve are joined to the other end. Suitably, a further screen is provided at the outlet and a hose connection to enable the water to be diverted directly for garden or like usage.

The float can be any shape provided that the shape affords closure of the collection chamber when raised by the rainwater. Typically the float will be a ball float which floats on the surface of the rainwater and is guided to its seat below the T-piece inlet by inwardly sloping walls of the collection chamber cap which preferably has a conical configuration.

Should it be desired to reduce the volume of the rainwater carrying capacity of the collection chamber, space occupying items which do not interfere with the operation of the float, can be placed within the collection chamber. Particularly, suitable space occupying items are additional float balls.

### BRIEF DESCRIPTION OF THE DRAWINGS

FIG. 1 is a front schematic cross-sectional view of a first flush water diverter according to one aspect of the present invention, and

FIG. 2 is a side schematic cross-sectional view of a first flush water diverter according to another aspect of the present invention.

### DESCRIPTION OF PREFERRED EMBODIMENTS

Preferred embodiments of the present invention will now be described with reference to the accompanying drawings, in each of which like reference numerals refer to like parts.

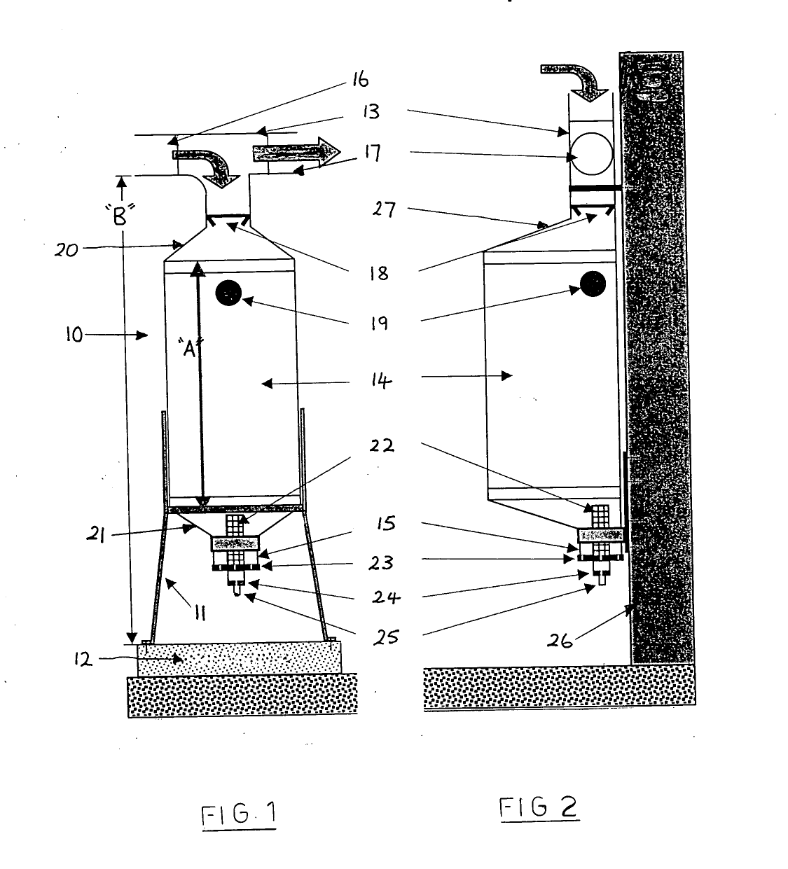

FIG. 1 illustrates a first flush water diverter 10 supported by a stand 11 on a concrete base 12. The diverter includes a T-piece 13, a rainwater collection chamber 14, and an outlet 15.

The T-piece (13) is joined to piping 16 which leads to a roof gutter and has an outlet 17 to a fresh water collection tank (not shown). A circular seat 18 is provided in the T-piece for a ball float 19 at the junction with a cap 20 for the collection chamber.

The bottom of the collection chamber 14 includes a downwardly sloping receptacle 21 in which is located a filter screen 22. The outlet 15 has a screw cap 23 with a o-ring seal and a flow control valve 24 to which a hose connection 25 is fitted.

FIG. 2 illustrates a very similar first flush water diverter to that shown in FIG. 1, the main differences being in that it is adapted for mounting to a wall 26 and in that it has a differently configured cap 27 and receptacle 28.

The length “A” of the collection chamber is chosen to suit the rainwater carrying capacity required for a particular roof size and Pollution Factor according to the previously defined formula.

The total distance between the base 12 and the inlet at the T-piece “B” is related to length “A” as exemplified in the Table.

It will be appreciated from the above discussion that a first flush water diverter can be expeditiously provided to suit whatever the roof areas and Pollution Factors are, by the simple expedient of cutting a collection chamber to the desired length from a standard 300 mm tube, fitting the cap and receptacle to opposing ends, and connecting the cap to a T-piece in the rainwater flow path. The objectives of the invention are thereby met and a useful product is made available to the public.

1. A first flush water diverter comprising a T-piece with associated rainwater collection chamber, which T-piece is adapted for connection in a rainwater flow path to intercept the flow of rainwater from a roof into a downpipe or directly to a storage or usage area, said collection chamber including a float which seals on a seat adjacent a T-piece inlet to the collection chamber when the collection chamber is charged with rainwater and having a diameter which is an integral multiple of the diameter of the T-piece inlet, the said collection chamber having a rainwater carrying capacity defined by the formula:
DF=RA×PF×1000
where
DF is the rainwater carrying capacity, or diversion factor, measured in litres,
RA is the associated roof area measured in square metres,
PF is the Pollution Factor for the roof location which is determined on sit and varies between 0.0005 for light pollution locations,
and wherein said collection chamber includes an outlet and associated flow control valve to regulate the flow of diverted rainwater from the collection chamber.

2. A first flush water diverter as claimed in claim 1, wherein the collection chamber is a pvc tube having a diameter of approximately 300 mm.

3. A first flush water diverter as claimed in claim 2, wherein the pvc tube has a length of between about 225 mm and 2005 mm.

4. A first flush water diverter as claimed in claim 1 or claim 2, wherein the collection chamber is adapted for support on a stand or for connection to a wall or post.

5. A first flush water diverter as claimed in claim 1 and wherein a hose connection is fitted to the flow control valve.

6. A first flush water diverter as claimed in claim 1, wherein a conical cap connects the T-piece to the collection chamber.

7. A first flush water diverter as claimed in claim 1, wherein a conical receptacle is fitted to the lower end of the collection chamber which houses the outlet.

8. A first flush water diverter as claimed in claim 1, wherein a filter screen is provided at the outlet.

9. A first flush water diverter as claimed in claim 1, wherein the float is a ball which freely floats on the surface of the rainwater which collects in the collection chamber.

10. A first flush water diverter as claimed in claim 1 and including a plurality of floating balls within the collection chamber.
